(19) United States
(12) Patent Application Publication
(10) Pub. No.: US 2005/0119419 A1
(43) Pub. Date: Jun. 2, 2005

(54) Agents binding and modifying rheology

(76) Inventors: Pierre Blanchard, Reyrieux (FR); Maurice Husson, Chalons en Champagne (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/502,794

(22) PCT Filed: Feb. 3, 2003
(86) PCT No.: PCT/FR03/00317

(30) Foreign Application Priority Data
Feb. 8, 2002 (FR) 0201535

(51) Int. Cl. C08F 20/54

(52) U.S. Cl. 525/331.9; 525/329.4; 526/303.1

(57) ABSTRACT

The present invention concerns copolymers containing carboxyl groups simultaneously with a function of a binding agent and a function of a rheology modifier or viscosity reducer or grinding aid agent for aqueous suspensions of pigments and/or mineral fillers, used to obtain grains of pigments and/or mineral fillers, reconstituted and formed from elementary particles with a specific BET surface ranging from 0.5 m²/g to 200 m²/g, grains that can easily be re-dispersed in thermoplastic resins. The invention also concerns the agglomerate minerals obtained and their uses.

The present invention concerns the technical sector of mineral fillers used, in particular, in the domain of paint and plastics and, more particularly, in the domain of thermoplastics filled with mineral matters.

The invention first concerns a copolymer simultaneously with the function of a binding agent and the function of a rheology modifier for aqueous suspensions of pigments and/or mineral fillers, that can be used, in a process for the preparation of reconstituted grains of pigments and/or mineral fillers, formed from elementary particles obtained by manufacture with wet or dry process, to obtain reconstituted grains of pigments and/or mineral fillers, formed from elementary particles with a specific BET surface ranging from 0.5 m²/g to 200 m²/g, as determined according to ISO standard 9277, compatible with thermoplastic resins, in particular with PVC resins (polyvinyl chloride resins), that is, that can be used to obtain agglomerated pigments and/or mineral fillers that can be easily re-dispersed in the aforementioned resins.

It should be noted that by rheology modifier the applicant means a compound capable of increasing or reducing the Brookfield™ viscosity of a suspension of mineral matter when this compound is added into the suspension in a quantity ranging from 0.1% to 10% in dry weight with respect to the dry weight of mineral matter.

When the Brookfield™ viscosity decreases, the term viscosity reducer is used, when it increases the term thickener is used.

The invention then concerns a rheology modifier for aqueous suspensions of pigments and/or mineral fillers that simultaneously has the function of a binding agent that can be used to obtain agglomerated pigments and/or mineral fillers that can easily be re-dispersed in thermoplastic resins, in particular in PVC resins (polyvinyl chloride resins).

The invention then concerns a grinding aid agent for aqueous suspensions of pigments and/or mineral fillers simultaneously with the function of a binding agent that can be used to obtain agglomerated pigments and/or mineral fillers that can easily be re-dispersed in thermoplastic resins, in particular in PVC resins (polyvinyl chloride resins).

It should be noted that by grinding aid agent the applicant means a viscosity reducing compound further facilitating grinding, i.e. facilitating the reduction in grain size of the particles of mineral matter in suspension when this compound is, added into the suspension in a quantity ranging from 0.1% to 10% in dry weight with respect to the dry weight of mineral matter.

The invention also concerns the use of the aforementioned copolymers as a binding agent and rheology modifier in a process to prepare reconstituted grains of pigments and/or mineral fillers, formed from elementary particles obtained by wet or dry process manufacture, in order to obtain reconstituted grains of pigments and/or mineral fillers, formed from elementary particles with a specific BET surface ranging from 0.5 m²/g to 200 m²/g, as determined according to ISO standard 9277, compatible with thermoplastic resins, in particular with PVC resins (polyvinyl chloride resins).

The invention also concerns the reconstituted grains of pigments and/or mineral fillers obtained with the use of the aforementioned copolymer.

These reconstituted grains of pigments and/or mineral fillers should easily be dispersed in plastic formulations when they are used in the domain of plastics and in paint formulations when they are used in the domain of paints.

The invention also concerns the use of these reconstituted grains of pigments and/or mineral fillers in the domains using fine powders and, in particular, in the domains of paint and thermoplastic resins, and in particular in the domain of PVC resins.

The invention also concerns thermoplastic resins and in particular PVC resins manufactured with the use of the aforementioned grains of pigments and/or mineral fillers.

The invention finally concerns objects injected, moulded or extruded from thermoplastic resins and, in particular, PVC resins manufactured with the use of the aforementioned grains of pigments and/or mineral fillers.

In fact, during the manufacture of plastics and, in particular, thermoplastic resins, in particular PVC resins, it is increasingly frequent to replace part of the costly resins, with cheaper mineral fillers and/or pigments, in order to reduce the cost of the plastic while at the same time improving, for example, its thermal or mechanical properties.

Mineral fillers and/or pigments such as, for example, natural or synthetic calcium carbonate, dolomites, magnesium hydroxide, kaolin, talc, gypsum, or even titanium oxide, are usually incorporated in the polymer matrix, by the skilled man, in the form of a fine powder or master-batch.

There are known various patent applications (EP 0 213 931, EP 0 359 362, EP 0 618 258, EP 0 628 609, FR 2 705 353) to obtain micro-spheres that can be used in thermoplastic resins, that are called <<free flowing >> by the skilled man, that is, that flow easily, but all of these techniques have the disadvantage that they are totally dependent on the viscosity of the suspension, still called “slurry”, obtained with the binding agent, thereby increasing the water concentration to evaporate in the rest of the micro-sphere manufacturing process.

Another known technique (EP 0 418 683) is used to obtain particles that are too hard and thereby too difficult to re-disperse.

This technique has the disadvantage that it provides compounds that are not easy to disperse in thermoplastic resins.

Thereby, to obtain mineral fillers and/or pigments that flow easily or are easy to handle and that can be easily dispersed in thermoplastic resins complying with the criteria of the final user in terms of mechanical and/or thermal resistance, the skilled man is faced with either the problem of a technique that does not allow the viscosity to be controlled during the manufacturing process of micro-spheres, thereby requiring high energy to eliminate the large amount of water present during the manufacture of these micro-spheres, or he is faced with a technique that provides particles that are too hard to be easily used in thermoplastic resins.

With these techniques available, the skilled man is also faced with the problem of the dependency of the viscosity of the suspension of pigments and/or mineral fillers as a function of its concentration in pigments and/or mineral fillers.

Therefore, the skilled man does not have any solution available to control viscosity of the initial suspension while providing reconstituted grains of pigments and/or mineral fillers, formed from elementary particles that flow easily and that are adapted to the application and are compatible with thermoplastic resins, in particular with PVC resins (polyvinyl chloride resins), that is, that can be used to obtain agglomerated pigments and mineral fillers that can be easily re-dispersed in the aforementioned resins.

Based on the aforementioned disadvantages concerning pigments and/or mineral fillers, the Applicant unexpectedly found that the use of a copolymer in part consisting of carboxyl groups, as an agent simultaneously with the function of a binding agent and the function of a rheology modifier for aqueous suspensions of pigments and/or mineral fillers, can be used to obtain agglomerated pigments and/or mineral fillers that can be easily re-dispersed in the aforementioned resins.

It should be noted that the binding efficacy of the aforementioned polymer used as a binding agent modifying the rheology of aqueous suspensions of pigments and/or mineral fillers, is, obviously as regards the Applicant, proportional to the molecular weight of the aforementioned copolymer, which is not the case with the viscosity reducing efficacy or even the efficacy of grinding aid.

Thereby, the prior art mainly describes the use of filler treatment agents that do not have a carboxyl function (EP 0 213 931, EP 0 359 362, EP 0 618 258, EP 0 628. 609, FR 2 705 353) and that do not result in finely ground pigments and/or mineral fillers or agents that only have a carboxyl function (EP 0 418 683) and can only be used to obtain pigments and/or fillers that are too hard to be obtained in the form of; elementary particles that are easily re-dispersed in thermoplastic resins.

Thereby, according to the invention, a copolymer simultaneously with the function of a binding agent and the function of a rheology modifier for aqueous suspensions of pigments and/or mineral fillers, that can be used, in a process for the preparation of reconstituted grains of pigments and/or mineral fillers, formed by elementary particles obtained by wet and dry process manufacture, to obtain reconstituted grains of pigments and/or mineral fillers, formed from elementary particles with a specific BET surface ranging from 0.5 m²/g to 200 m²/g, as determined according to ISO standard 9277, compatible with thermoplastic resins, in particular with PVC resins (polyvinyl chloride resins), is characterised in that it consists of, as expressed in weight:
a) from 3% to 75%, preferably from 4% to 70% of at least one monomer with a carboxyl function,
b) from 97% to 25%, preferably from 96% to 30% of at least one monomer with an ester, or amide acrylic or vinyl function, and
c) from 0% to 5% of at least one acid monomer containing the sulphur atom or the phosphorous atom or their mixtures,
d) 0% to 5% in weight of at least one cross-linking monomer chosen from among the monomers with at least two ethylenic insaturations,
the sum of monomers a), b), c) and d) equals 100%.

More specifically, when the copolymer, according to the invention, simultaneously has the function of a binding agent and the function of a viscosity reducer of aqueous suspensions of pigments and/or mineral fillers, that can be used, in the preparation of reconstituted grains of pigments and/or mineral fillers, formed from elementary particles obtained by wet or dry process manufacture, to obtain reconstituted grains of pigments and/or mineral fillers, formed from elementary particles with a specific BET surface ranging from 0.5 m²/g to 200 m²/g, as determined according to ISO standard 9277, compatible with thermoplastic resins, in particular with PVC resins (polyvinyl chloride resins), the polymer according to the invention is characterised in that it consists of, as expressed in weight:
a) from 10% to 75% of at least one monomer with a carboxyl function,
b) from 90% to 25% of at least one monomer with an ester, or amide acrylic, or vinyl,
c) from 0% to 5% of at least one acid monomer containing the sulphur atom or the phosphorus atom or their mixtures,
d) 0% to 5% in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g.

The molecular weight of homopolymers or copolymers is measured on the form of the ammonium hydroxide neutralised polymer and according to method (A) described below and will be called intrinsic viscosity in the rest of the present application as well as in the claims.

To do this, we prepare four flasks one of which contains the 120 g/l reference salt solution and the other three contain the compound, for which it is necessary to determine the intrinsic viscosity, neutralised to pH 8 by ammonia and diluted at different concentrations. These different concentrations equal 10 g/l, 20 g/l and 30 g/l in the 120 g/l salt solution.

The specific viscosity of each solution is then determined using a Schott AVS/500 viscometer equipped with an Ubbelohde tube (reference: 53010/I) and a 0.01 constant and the curve [(specific viscosity)/concentration] is plotted as a function of the concentration.

The linear part of the curve is used to obtain the intrinsic viscosity according to the following equation:
Intrinsic viscosity=Limit (of the ratio of the specific viscosity over the concentration) when the concentration approaches zero. (Chimie macromoleculaire II, 1972 Edition, Chapter IV, p. 211 to 259).

Also more specifically, when the copolymer according to the invention simultaneously has the function of a binding agent and the function of a grinding aid agent of aqueous suspensions of pigments and/or mineral fillers, that can be used, in the preparation of reconstituted grains of pigments and/or mineral fillers, formed from elementary particles obtained from wet or dry process manufacture, to obtained reconstituted grains of pigments and/or mineral fillers, formed from elementary particles with a specific BET surface ranging from 0.5 m²/g to 200 m²/g, as determined according to ISO standard 9277, compatible with thermoplastic resins, in particular with PVC resins (polyvinyl chloride resins), the copolymer according to the invention is characterised in that it consists of, as expressed in weight:
a) from 30% to 75% of at least one monomer with a carboxyl function,
b) from 70% to 25% of at least one monomer with an ester, or amide acrylic, or vinyl function,
c) from 0% to 5% of at least one acid monomer containing the sulphur atom or the phosphorus atom or their mixtures,
d) 0% to 5% in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g, measured according to method (A).

According to the invention, all of these copolymers are more particularly characterised in that:
a) the monomer(s) with a carboxyl function are chosen from among the anionic monomers with ethylenic insaturation and monocarboxylic function such as acrylic or methacrylic acid or even the hemiesters of diacids such as the monoesters in C₁ to C₄ of maleic or itaconic acid, or their mixtures, or are chosen from among the anionic monomers with ethylenic insaturation and dicarboxylic or sulphonic or phosphoric or phosphonic function or their mixture chosen from among the monomers with ethylenic insaturation and dicarboxylic function such as itaconic, maleic acid or even the anhydrides of carboxylic acids, such as maleic anhydride,
b) the monomer(s) with an ester, or amide acrylic, or vinyl function are chosen from among acrylamide or methacrylamide whether or not substituted or their derivatives and their mixtures or from among one or several non hydrosoluble monomers such as the branched or linear alkyl acrylates or methacrylates, or from among the vinyl esters such as vinyl acetate,
c) the acid monomer(s) containing the sulphur atom or the phosphorus atom or their mixtures are chosen from among monomers with ethylenic insaturation and sulphonic function such as acryamido-methyl-propane-sulphonic acid, sodium methallylsulphonate, sulphonic vinyl acid and sulphonic styrene acid or are chosen from among the monomers with ethylenic insaturation and phosphoric function such as the phosphate of ethylene glycol methyacrylate, mthe phosphate of propylene glycol methyacrylate, the phosphate of ethylene glycol acrylate, the phosphate of propylene glycol acrylate and their ethoxylates or are chosen from among the monomers with ethylenic insaturation and phosphonic function such as phosphonic vinyl acid, or their mixtures,
d) the monomer(s) with at least two ethylenic insaturations are chosen in a non, limiting manner from a group consisting of ethylene glycol dimethacrylate, trimethylopropanetriacrylate, allyl acrylate, the allyl maleates, methylene-bis-acrylamide, methylene-bis-methacrylamide, tetrallyloxyethane, the triallylcyanurates, the allylic ethers obtained from polyalchols such as pentaerythritol, sorbitol, sucrose or others.

The copolymer used according to the invention is obtained by known radical co-polymerisation processes.

This copolymer obtained in acid form and possibly distilled should be totally or partially neutralised by one or several neutralising agents possessing a monovalent neutralising function or a polyvalent neutralising function such as, for example, for the monovalent function those chosen from among the group consisting of the alkaline cations, in particular sodium, potassium, lithium, ammonium or the primary, secondary or tertiary aliphatic and/or cyclic amines such as, for example, stearylamine, the ethanolamines (mono-, di-, triethanolamine), mono and diethylamine, cyclohexylamine, methylcyclohexylamine or better still for the polyvalent function those chosen from among the group consisting of divalent alkaline-earth cations, in particular magnesium and calcium, or zinc, as well as by the trivalent cations, in particular aluminium, or by certain cations with a higher valence.

Each neutralising agent intervenes according to the specific stoichiometry of each valence function.

Preferentially, this copolymer is neutralised by the ammonium ion.

According to another variant, the copolymer obtained from the co-polymerisation reaction may possibly, before or after the total or partial neutralisation reaction, be treated and separated into several phases, in accordance with the static or dynamic methods familiar to the skilled man, by one or several polar solvents in particular belonging to the group consisting of water, methanol, ethanol, propanol, isopropanol, the butanols, acetone, tetrahydrofurane or their mixtures.

One of the phases then corresponds to the copolymer used according to the invention as a binding agent modifying the rheology of the minerals in aqueous suspension.

The invention also concerns the use of the aforementioned copolymers as a rheology modifier for aqueous suspensions of pigments and/or mineral fillers simultaneously with the function of a binding agent and that can be used to obtain grains of pigments and/or mineral fillers reconstituted and formed from elementary particles with a specific BET surface ranging from 0.5 m²/g to 200 m²/g, as determined according to ISO standard 9277. These grains can easily be re-dispersed in thermoplastic resins.

This use is characterised in that the aforementioned agent consists of, as expressed in weight:
a) from 3% to 75%, preferably from 4% to 70% of at least one monomer with a carboxyl function,
b) from 97% to 25%, preferably from 96% to 30% of at least one monomer with an ester, or amide acrylic, or vinyl function,
c) from 0% to 5% of at least one acid monomer containing the sulphur atom or the phosphorus atom or their mixtures,
d) from 0% to 5% in weight of at least one cross-linking monomer chosen from among the monomers with at least two ethylenic insaturations,
the sum of monomers a), b), c) and d) equals 100%,
is characterised in that the aforementioned copolymer is used at the rate of 0.1% to 10% in dry weight compared with the dry weight of the pigments and/or mineral fillers, and
is characterised in that the agglomerated grains can be re-dispersed in thermoplastic resins, in particular with PVC resins (polyvinyl chloride resins), that is since there are at least 3 grains with a diameter superior or equal to 0.2 mm in the re-dispersion test based on the protocol to measure the dispersing power of the micro-granules in PVC resins.

The invention also concerns the use of the aforementioned copolymers as viscosity reducer for aqueous suspensions of pigments and/or mineral fillers simultaneously with the function of a binding agent.

This use is characterised in that the aforementioned agent consists of, as expressed in weight:
a) from 10% to 75% of at least one monomer with a carboxyl function,
b) from 90% to 25% of at least one monomer with an ester, or amide acrylic, or vinyl function,
c) from 0% to 5% of at least one acid monomer containing the sulphur atom or phosphorus atom or their mixtures,
d) from 0% to 5% in weight of at least one cross-linking monomer chosen from among the monomers with at least two ethylenic insaturations,
the sum of monomers a), b), c) and d) equals 100%,
is characterised in that the aforementioned copolymer is used at the rate of 0.1% to 10% in dry weight comnpared with the dry weight of pigments and/or mineral fillers,
and is characterised in that it has a molecular weight corresponding to an intrinsic viscosity ranging from 5 ml/g to 20 ml/g, and preferably from 7 ml/g to 15 ml/g, as measured according to method (A).

Finally, the invention concerns the use of the aforementioned copolymers as a grinding aid simultaneously with the function of a binding agent.

This use is characterised in that the aforementioned agent consists of, as expressed in weight:
a) from 30% to 75% of at least one monomer with a carboxyl function,
b) from 70% to 25% of at least one monomer with an ester, or amide acrylic, or vinyl function,
c) from 0% to 5% of at least one acid monomer containing the sulphur atom or the phosphorus atom or their mixtures,
d) from 0% to 5% in weight of at least one cross-linking monomer chosen from among the monomers with at least two ethylenic insaturations,
the sum of monomers a), b), c) and d) equals 100%,
is characterised in that the aforementioned copolymer is used at the rate of 0.1% to 10% in dry weight compared with the dry weight of the pigments and/or mineral fillers, and
is characterised in that it has a molecular weight corresponding to an intrinsic viscosity ranging from 5 ml/g to 20 ml/g, and preferably from 7 ml/g to 15 ml/g, as measured according to method (A).

The invention also concerns the reconstituted grains of pigments and/or mineral fillers obtained with the use of the aforementioned copolymer.

These reconstituted grains of pigments and/or mineral fillers are characterised in that they contain from 0.1% to 10% in weight, compared with the dry weight of the pigments and/or mineral fillers, of the copolymer according to the invention.

These reconstituted grains of pigments and/or mineral fillers are more specifically characterised in that the filler and/or pigment is chosen from among natural calcium carbonate, in particular calcite, chalk or marble, synthetic calcium carbonate still called precipitated calcium carbonate, the dolomites, magnesium hydroxide, kaolin, talc, gypsum, titanium oxide or hydrotalcite or their mixtures, or any other filler and/or pigment usually used in the domain of paints and/or plastics.

The invention also concerns the use of these reconstituted grains of pigments and/or mineral fillers in domains using fine powders and, in particular, in the domains of paints and/or thermoplastic resins and, in particular, in the domain of PVC resins and polyolefin resins.

The invention also concerns thermoplastic resins and, in particular, PVC and polyolefin resins manufactured by the use of the aforementioned grains of pigments and/or mineral fillers.

These resins are characterised in that they contain, with respect to the total weight of resin, from 1% to 85% in dry weight, preferably from 2% to 40% in dry weight, of grains of pigments and/or mineral fillers.

Finally, the invention concerns objects injected, moulded or extruded from thermoplastic resins and, in particular, PVC resins manufactured by the use of the aforementioned grains of pigments and/or mineral fillers.

In practice, according to the invention, the first phase of the operation to obtain the agglomerated grains consists of the preparation of a suspension of pigments and/or mineral fillers including the pigment and/or mineral filler, the copolymer used according to the invention and then various additives such as lubricants chosen from among the emulsions or suspensions of acid with from 8 to 30 saturated or unsaturated carbon atoms such as, in particular, the emulsions or suspensions of stearic, behenic, palmitic or other acids, the suspensions of fatty acid salts such as, in particular, the suspensions of calcium or ammonium stearate, the emulsions of oxidised polyethylene waxes or the acrylic-ethylene acid copolymers; such as the thermal or UV stabilisers currently used in the PVC industry, that is, heavy metal salts including lead or natural or synthetic components made of calcium, zinc, aluminium, magnesium, barium or others; such as colorants or coloured pigments, impact modifiers or <<processing aids >> currently used in the domain of plastics, possibly found in emulsion form.

In a second phase, the suspension obtained is dried by a classic drying procedure such as atomisation or spraying.

This drying phase can be carried out in one or two, more or less progressive, steps.

These agglomerated grains, free-flowing and easily re-dispersible in thermoplastic resins, can eventually be diluted with different components such as lubricants, mineral stearates and other components usually used in the domain of plastics, before being used in the thermoplastic resins.

The value of the invention will be better understood by means of the following, non limiting, examples.

### EXAMPLE 1

This example concerns the determination of the rheology modifying property of the binding agent used according to the invention.

For this reason, for each of the following tests, carried out on an aqueous suspension of calcium carbonate, the Brookfield™ viscosity of the suspension is determined before and after the addition of the binding agent.

A sample of the test calcium carbonate suspension is introduced in a flask, and after shaking for 10 minutes, the Brookfield™ viscosity is measured using an HBD-VI Brookfield™ viscometer, at a temperature of 25° C. and a speed of rotation of 10 and 100 rpm with the suitable spindle. This provides the Brookfield™ viscosity of the suspension before the addition of the binding agent, the rheology modifier.

After this reading is carried out, the rheology modifying binding agent is added.

After 10 minutes of shaking, a calcium carbonate suspension is obtained containing the binding agent, and the Brookfield™ viscosity is measured using an HBD-VI Brookfield™ viscometer, at a temperature of 25° C. and a speed of rotation of 10 and 100 rpm with the suitable spindle. This provides the Brookfield™ viscosity of the suspension after the addition of the binding agent, the rheology modifier.

These different readings were taken for the following tests.

Test No. 1:

This test, illustrating the prior art, uses an aqueous suspension of chalk with a specific BET surface of 4.5 m²/g determined according to ISO standard 9277, where the concentration in dry matter equals 69.1% and where the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a methyl polymethyacrylate.

Test No. 2:

This test, illustrating the prior art, uses an aqueous suspension of chalk with a specific BET surface of 4.5 m²/g as determined according to ISO standard 9277, where the dry matter concentration equals 69.1% and the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a polyvinyl acetate sold under the name of Mowilith™ LDM by Clariant.

Test No.3:

This test, illustrating the invention, uses an aqueous suspension of chalk with a specific BET surface of 4.5 m²/g as determined according to ISO standard 9277, where the concentration in dry matter equals 69.1% and where the granulometry is such that the diameter of 61.8% of the particles does not exceed 2 μm and the diameter of 21.7% of the particles does not exceed 1 μm as determined with a Sedigraph™ 5100-type granulometer, and 1.0% in dry weight of a copolymer, neutralised at 100% in moles by ammonia and consisting of:
a) 15.0% in weight of acrylic acid as monomer with a carboxyl function;
b) 10.0% in weight of methyl methacrylate as monomer with an acrylic ester function;
c) 40.0% in weight of ethyl acrylate as monomer with an acrylic ester function;
d) 35.0% in weight of vinyl acetate as monomer with a vinyl ester function.
   Test No. 4:

This test, illustrating the invention, uses an aqueous suspension of chalk with a specific BET surface of 4.5 m²/g as determined according to ISO standard 9277, where the dry matter concentration equals 69.1% and where the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a copolymer neutralised at 100% in moles by ammonia and consisting of:
a) 30.0% in weight of acrylic acid as monomer with a carboxyl function;
b) 70.0% in weight of ethyl acrylate as a monomer with an acrylic ester function.
   Test No. 5:

This test, illustrating the invention, uses an aqueous suspension of chalk with a specific BET surface of 4.5 m²/g as determined according to ISO standard 9277, where the dry matter concentration equals 69.1% and where the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a copolymer neutralised at 100% in moles by ammonia and consisting of:
a) 15.0% in weight of methacrylic acid as monomer with a carboxyl function;
b) 10.0% in weight of methyl methacrylate as monomer witfi an acrylic ester function;
c) 75.0% in weight of ethyl acrylate as monomer with an acrylic ester function.
   Test No. 6:

This test, illustrating the invention, uses an aqueous suspension of chalk with a specific BET surface of 4.5 m²/g as determined according to ISO standard 9277, where the dry matter concentration equals 69.1% and where the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a copolymer neutralised at 80% in moles by sodium carbonate and consisting of:
a) 4.0% in weight of acrylic acid as monomer with a carboxyl function;
b) 96.0% in weight of methyl methacrylate as monomer with an acrylic ester function;
   Test No. 7:

This test, illustrating the invention, uses an aqueous suspension of chalk with a specific BET surface of 4.5 m²/g as determined according to ISO standard 9277, where the dry matter concentration equals 69.1% and where the granulometry is such that the diameter of 61.8% of the particles does not exceed 2 μm and the diameter of 21.7% of the particles does not exceed 1 μm as determined with a Sédigraph™ 5100-type granulometer, and 1.0% in dry weight of a copolymer neutralised at 100% in moles by ammonia and consisting of:
a) 71.3% in weight of acrylic acid as monomer with a carboxyl function;
b) 28.7% in weight of butyl acrylate as monomer with an acrylic ester function;

All of these experimental results are provided in Table 1.

TABLE 1

| | | Prior Art | Prior Art | Invention | Invention | Invention | Invention | Invention |
|---|---|---|---|---|---|---|---|---|
| TEST No. | | 1 | 2 | 3 | 4 | 5 | 6 | 7 |
| Methyl methacrylate | % | 100% | — | 10 | — | 10 | 96 | — |
| Butyl acrylate | % | — | — | — | — | — | — | 28.7 |
| Ethyl acrylate | % | — | — | 40 | 70 | 75 | — | — |
| Vinyl acetate | % | — | 100% | 35 | — | — | — | — |
| Acrylic acid | % | — | — | 15 | 30 | — | 4 | 71.3 |
| Methacrylic acid | % | — | — | — | — | 15 | — | — |
| Dry dispersing agent | % | 1 | 1 | 1 | 1 | 1 | 1 | 1 |
| Concentration of the slurry | % | 69.1 | 69.1 | 69.1 | 69.1 | 69.1 | 69.1 | 69.1 |
| Brookfield viscosity at 25° C. | 10 rpm | 16,000 | 20,000 | 16,000 | 20,000 | 20,000 | 11,200 | 11,200 |
| Before addition of the | 100 rpm | 3,800 | 4,000 | 4,000 | 4,000 | 4,000 | 2,400 | 2,400 |
| copolymer | | | | | | | | |
| Brookfield viscosity at 25° C. | 10 rpm | 18,000 | 18,000 | 600 | 3,300 | 500 | 1,300 | 610 |
| After addition of the copolymer | 100 rpm | 6,600 | 4,000 | 200 | 540 | 150 | 240 | 110 |

Table 1 demonstrates the use of the copolymer according to the invention as a rheology modifier or as a viscosity reducer when their molecular weight corresponding to an intrinsic viscosity ranging from 5 mug to 20 ml/g, and preferably from 7 ml/g to 15 ml/g, as measured according to method (A) previously described.

### EXAMPLE 2

The purpose of this example is to illustrate the use of the copolymer according to the invention simultaneously with the function of a binding agent and a grinding aid, concerns the grinding of a suspension of natural calcium carbonate and, more -particularly, a Champagne chalk with a specific BET surface of 2.6 m²/g, as determined according to ISO standard 9277, where the diameter of 36% of the particles does not exceed 2 82 m as determined with a Sédigraph™ 5100-type granulometer to refine it in a micro-particle suspension.

For this purpose, for each test, the grinding aid agent is introduced according to the invention to be tested, in an aqueous suspension with 60% dry matter of a Champagne chalk where the diameter of 36% of the particles does not exceed 2 μM as determined with a Sédigraph™ 5100-type granulometer.

The suspension circulates in a Dyno-Mill™ grinder with a set cylinder and revolving pulser, where the grinder consists of corundum balls with a diameter ranging from 0.6 millimetre to 1 millimetre.

The total volume occupied by the grinder is 1150 cubic centimetres while the weight is 2900 g.

The volume of the grinding chamber is 1400 cubic centimetres.

The peripheral speed of the grinder is 10 metres per second.

The calcium carbonate suspension is recycled at the rate of 18 litres per hour.

The Dyno-Mill™ outlet is equipped with a 200 micrometer mesh separator that is used to separate the suspension resulting from the grinding and the grinder.

The temperature during each grinding test is maintained at about 60° C.

At the end of the grinding (T₀), a sample of the pigment suspension is collected in a flask. The granulometry of this suspension (% of the particles under 2 μm and 1 μm) is measured with a Sédigraph™ 5100-type granulometer manufactured by Micromeritics.

The Brookfield™ viscosity of the suspension is measured with a Brookfield™ RVT viscometer at a temperature of 23° C. and rotation speed of 10 and 100 rpm with the adequate spindle.

Therefore, the following grinding aid agents are tested.

Test No. 8:

This test, illustrating the invention, uses 0.20% in dry weight, compared with the dry weight of the chalk, of a polymer neutralised at 100% by ammonia, with an intrinsic viscosity equal to 8.1 ml/g measured according to the aforementioned method (A) and consisting of:
a) 30.0% in weight of acrylic acid as anionic monomer with a carboxyl function;
b) 70% in weight of ethyl acrylate as monomer with an acrylic ester function. The aqueous suspension of chalk thereby refined has the following characteristics:
Concentration in Champagne chalk: 56.2%;
Brookfield™ viscosity at 10 rpm.=100 mPas;
Brookfield™ viscosity at 100 rpm.=70 mPas;
% particles not exceeding 2 μm=89.4%;
% particles not exceeding 1 μm=45.2%;
Specific BET surface equal to 6.4 m²/g, as determined according to ISO standard 9277.
   Test No. 9:

This test, illustrating the invention, uses 0.15% in dry weight, compared with the dry weight of the chalk, of a polymer neutralised at 100% by ammonia, with an intrinsic viscosity equal to 11.2 ml/g measured according to the aforementioned method (A) and consisting of:
a) 71.3% in weight of acrylic acid as anionic monomer with a carboxyl function;
b) 28.7% in weight of butyl acrylate as monomer with an acrylic ester function.

The aqueous suspension of chalk thereby refined has the following characteristics:
Concentration in Champagne chalk: 58.8%;
Brookfield™ viscosity at 10 rpm.=125 mPas;
Brookfield™ viscosity at 100 rpm.=70 mPas;
% particles not exceeding 2 μm=91.3%;
% particles not exceeding 1 μm=62%;
Specific BET surface equal to 6.5 m²/g, as determined according to ISO standard 9277.

Examination of the results of the different tests in the example demonstrates the use of copolymer according to the invention as grinding aid agent when the molecular weight corresponds to an intrinsic viscosity ranging from 5 ml/g to 20 ml/g, and preferably from 7 mug to 15 ml/g, measured according to method (A) described above.

### EXAMPLE 3

The purpose of this example is to illustrate that the agglomerated grains according to the invention can be re-dispersed in thermoplastic resins, in particular in PVC resins.

To do so, each of the suspensions in the previous tests is dried in the form of reconstituted grains using a pulveriser commercialised by Sacmi (Italy), a mixture is made with 80 parts in weight of a PVC formulation and 20 parts in weight of the mineral filler to test in the form of reconstituted grains.

The PVC formulation used contains the following for 100 parts of PVC resin commercialised under the name Evipol SH 6530 by European Vinyls Corp.(Italy):
1.5 parts of tribasic lead sulphate;
1.3 parts of dibasic lead stearate;
0.6 parts of calcium stearate;
0.05 parts of E wax commercialised by Clariant GmbH.

This mixture is made and then extruded using a Rheomex™ equipped with a twin-screw type extruder without mixing component (reference 557-2211 from Haake) with the following machine parameters:
Speed of rotation of the screw: 30 rpm;
Temperature of extrusion zone 1: 160° C.;
Temperature of extrusion zone 2: 170° C.;
Temperature of extrusion zone 3: 180° C.;
Temperature of extruder head 1: 180° C.;

With a feed hopper cooled by a circulation of water and manual feed of the screw.

The extrudate at the outlet is then a flat strip 40 mm wide guided by a calender with a “drawing bench™ index of 120.

The dispersal of the reconstituted grains is considered to be good if less than 3 agglomerates with a diameter exceeding 0.2 mm is found on a 20 cm length of strip. It is considered to be poor if at least 3 agglomerates of this diameter appear in the 20 cm.

The different tests and results obtained are:

Test No. 10

This test illustrates the prior art and uses a calcium carbonate suspension obtained by the use of a homopolymer of acrylic acid with an intrinsic viscosity of 8 ml/g.

An innumerable quantity of agglomerates of diameter exceeding 0.2 mm appears on 20 cm of strip.

The poor appearance of the surface can also be noted. The dispersion is considered to be poor.

Test No. 11:

This test illustrates the invention and uses grains reconstituted from the aqueous suspension in test No. 3.

No agglomerate is found on the 20 cm of strip. The dispersion is considered to be good.

Test No. 12:

This test illustrates the invention and uses grains reconstituted from the aqueous suspension in test No. 4.

No agglomerate is found on the 20 cm of strip. The dispersion is considered to be good.

Test No. 13:

This test illustrates the invention and uses grains reconstituted from the aqueous suspension in test No. 5.

No agglomerate is found on the 20 cm of strip. The dispersion is considered to be good.

Test No. 14:

This test illustrates the invention and uses grains reconstituted from the aqueous suspension in test No. 6.

No agglomerate is found on the 20 cm of strip. The dispersion is considered to be good.

Test No. 15:

This test illustrates the invention and uses grains reconstituted from the aqueous suspension in test No. 7.

No agglomerate is found on the 20 cm of strip. The dispersion is considered to be good.

Test No. 16:

This test illustrates the invention and uses grains reconstituted from the aqueous suspension in test No. 8.

No agglomerate is found on the 20 cm of strip. The dispersion is considered to be good.

Test No. 17:

This test illustrates the invention and uses grains reconstituted from the aqueous suspension in test No. 9.

No agglomerate is found on the 20 cm of strip. The dispersion is considered to be good.

Scrutiny of the results of the different tests of the example shows that the agglomerated grains according to the invention are redispersible in thermoplastic resins and in particular in PVC resins.

### EXAMPLE 4

The purpose of this example is to illustrate the mechanical properties obtained with a PVC resin containing grains of reconstituted mineral filler, according to the invention.

The following tests were carried out for this purpose.

Test No. 18:

This control test, uses 15 pcr of Champagne chalk treated with industrial quality stearic acid. Before treatment, the specific BET surface of this chalk is 5 m²/g as determined according to ISO standard 9277, and the granulometry is such that the diameter of 60% of the particles does not exceed 2 micrometers as determined with a Sédigraph™ 5100-type granulometer.

The Charpy impact is determined by the preparation of a mixture consisting of a PVC formulation and the test mineral filler.

The PVC formulation used contains the following for 100 parts of PVC resin commercialised under the name Evipol SH 6530 by European Vinyls Corp. (Italy):
1.5 parts of tribasic lead sulphate;
1.3 parts of dibasic lead stearate;
0.6 parts of calcium stearate;
0.05 parts of E wax commercialised by Clariant GmbH;
15 parts of the test mineral filler.

This mixture is made in a rapid 14 litre Papenmeier™ mixer at a speed of 2,200 rpm corresponding to a peripheral speed of 25 m/s, under a temperature of 100° C.-105° C. during the first 5 minutes and then a temperature reduced to 50° C. by stirring at 600 rpm corresponding to a peripheral speed of 7 m/s.

200 cm³ of mixture is then removed for gelation.

This gelation is carried out on a two-cylinder Collin™ mixer (diameter of the cylinder equal to 150 mm and the width equal to 400 mm), with a cylinder speed of about 20 rpm to 24 rpm and a circuit heating temperature set at 195° C.

Once the gelation is complete, a 0.55 mm thick sheet is obtained.

A plate is then pressed in a mould under a compression press at 190° C. for 2 minutes under 10 kN and for 3 minutes under 300 kN in order to obtain a plate on which the sample is countersunk. The impact resistance at 23° C. is determined according to DIN standard 53453.

The value obtained for the Charpy impact equals 5.3 kJ/m².

Test No. 19:

In this test, illustrating the invention, a Champagne chalk with a specific BET surface of 2.2 m²/g as determined according to ISO standard 9277, and a granulometry so that the diameter of 32.5% of the particles does not exceed 2 micrometers as determined with a Sédigraph™ 5100-type granulometer, is first ground according to the same procedure as that used in example 2 by introduction, of 0.2% in dry weight, as compared with the dry weight of chalk, of the polymer used in test No. 7.

The aqueous suspension of chalk thereby refined has a concentration in dry weight of chalk of 60%, a specific BET surface of 5.0 m²/g as determined according to ISO standard 9277, and a granulometry so that the diameter of 60.0% of the particles does not exceed 2 micrometers as determined with a Sédigraph™ 5100-type granulometer.

Then, 0.2% in dry weight, compared with the dry weight of the chalk, of the same polymer is added as well as 1% in dry weight, compared with the dry weight of the chalk, of an aqueous suspension of calcium stearate with 50% dry matter.

After homogenisation of the medium for 5 minutes, the suspension is dried in the form of reconstituted grains with a lance pulveriser commercialised by Sacmi (Italy). The Charpy impact is then measured using the same procedure as that used in test No. 18.

The value Charpy impact obtained for the equals 6.4 kJ/m².

Test No. 20

In this test, illustrating the invention, a Champagne chalk with a specific BET surface of 2.2 m²/g, as determined according to ISO standard 9277, and a granulometry so that the diameter of 32.5% of the particles does not exceed 2 micrometers as determined with a Sédigraph™ 5100-type granulometer, is first ground according to the same procedure as that used in example 2 by introduction, of 0.2% in dry weight, as compared with the dry weight of chalk, of the polymer used in test No. 7.

The aqueous suspension of chalk thereby refined has a concentration in dry weight of chalk of 60%, a specific BET surface of 5.0 m²/g as determined according to ISO standard 9277, and a granulometry so that the diameter of 60.0% of the particles does not exceed 2 micrometers as determined with a Sédigraph™ 5100-type granulometer.

Then, 0.4% in dry weight, compared with the dry weight of the chalk, of the same polymer is added as well as 1% in dry weight, compared with the dry weight of the chalk, of an aqueous suspension of calcium stearate with 50% dry matter.

After homogenisation of the medium for 5 minutes, the suspension is dried in the form of reconstituted grains with a lance pulveriser commercialised by Sacmi (Italy). The Charpy impact is then measured using the same procedure as that used in test No. 18.

The value Charpy impact obtained for the equals 6.3 kJ/m².

Test No. 21:

In this control test, a Champagne chalk with a specific BET surface of 8.5 m²/g before treatment, as determined according to ISO standard 9277, and a granulometry so that the diameter of 90% of the particles does not exceed 2 micrometers as determined with a Sédigraph™ 5100-type granulometer, the Charpy impact is determined using the same procedure as that used in test No. 18.

The value Charpy impact obtained for the equals 5.8 kJ/m².

Test No. 22:

In this test, illustrating the invention, a Champagne chalk with a specific BET surface of 2.2 m²/g, as determined according to ISO standard 9277, and a granulometry so that the diameter of 32.5% of the particles does not exceed 2 micrometers as determined with a Sédigraph™ 5100-type granulometer, is first ground according to the same procedure as that used in example 2 by introduction, of 0.4% in dry weight, as compared with the dry weight of chalk, of the polymer used in test No. 7.

The aqueous suspension of chalk thereby refined has a concentration in dry weight of chalk of 50%, a specific BET surface of 8.6 m²/g, as determined according to ISO standard 9277, and a granulometry so that the diameter of 90.0% of the particles does not exceed 2 micrometers as determined with a Sédigraph™ 5100 granulometre.

Then, 0.2% in dry weight, compared with the dry weight of the chalk, of the same polymer is added

After homogenisation of the medium for 5 minutes, the suspension is dried in the form of reconstituted grains with a lance pulveriser commercialised by Sacmi (Italy). The Charpy impact is then measured using the same procedure as that used in test No. 18.

The value Charpy impact obtained for the equals 6.8 kJ/m².

Test No. 23

In this test, illustrating the invention, a Champagne chalk with a specific BET surface of 2.2 m²/g, as determined according to ISO standard 9277, and a granulometry so that the diameter of 32.5% of the particles does not exceed 2 micrometers as determined with a Sédigraph™ 5100-type granulometer, is first ground according to the same procedure as that used in example 2 by introduction, of 0.4% in dry weight, as compared with the dry weight of chalk, of the polymer used in test No. 7.

The aqueous suspension of chalk thereby refined has a concentration in dry weight of chalk of 50%, a specific BET surface of 8.6 m²/g as determined according to ISO standard 9277, and a granulometry so that the diameter of 90.0% of the particles does not exceed 2 micrometers as determined with a Sédigraph™ 5100 granulometre.

Then, 0.4% in dry weight, compared with the dry weight of the chalk, of the same polymer is added.

After homogenisation of the medium for 5 minutes, the suspension is dried in the form of reconstituted grains with a lance pulveriser commercialised by Sacmi (Italy). The Charpy impact is then measured using the same procedure as that used in test No. 18.

The value Charpy impact obtained for the equals 6.6 kJ/m².

Test No. 24

In this test, illustrating the invention, a Champagne chalk with a specific BET surface of 2.2 m²/g, as determined according to ISO standard 9277, and a granulometry so that the diameter of 32.5% of the particles does not exceed 2 micrometers as determined with a Sédigraph™ 5100 granulometre, is first ground according to the same procedure as that used in example 2 by introduction, of 0.4% in dry weight, as compared with the dry weight of chalk, of the polymer used in test No. 7.

The aqueous suspension of chalk thereby refined has a concentration in dry weight of chalk of 50%, a specific BET surface of 8.6 m²/g as determined according to ISO standard 9277, and a granulometry so that the diameter of 90.0% of the particles does not exceed 2 micrometers as determined with a Sédigraph™ 5100-type granulometer.

Then, 0.6% in dry weight, compared with the dry weight of the chalk, of the same polymer is added

After homogenisation of the medium for 5 minutes, the suspension is dried in the form of reconstituted grains with a lance pulveriser commercialised by Sacmi (Italy). The Charpy impact is then measured using the same procedure as that used in test No. 18.

The value Charpy impact obtained for the equals 7.0 kJ/m².

The results obtained in the different tests in the example demonstrate that a PVC resin containing reconstituted grains of mineral filler according to the invention have a higher resistance to Charpy impact than a control resin of the prior art. This provides a perfect dispersal of the reconstituted grains in the polymer matrix.

### EXAMPLE 5

The purpose of this example is to show that the agglomerated grains according to the invention are redispersible in polyolefin resins and in particular in polyethylene resins.

To do so, after drying each of the following test suspensions nos. 25 to 27 in the form of reconstituted grains, using a spray gun marketed by Sacmi (Italy), a mixture is made with 0.15 parts of thermal stabiliser sold by Ciba-Geigy under the name of Irganox™ 1010, 50 parts by weight of a low density polyethylene resin (LLDPE) marketed under the name of Dowlex™ SC 2107 by Dow and 50 parts by weight of the mineral filler to be tested in the form of reconstituted grains.

This mixture is prepared with the aid of a Buss™ PR 46 fitted with a twin-screw extruder, then is brought to a fill level of 25% in the aforementioned polyethylene resin and is extruded onto a laboratory single-screw with the following parameters:
Screw rotation speed: 80 rpm;
Temperature of extrusion zone 1: 180° C.;
Temperature of extrusion zone 2: 190° C.;
Temperature of extrusion zones 3 to 9 : 200° C.

The dispersion of the reconstituted grains is then regarded as good if there is no agglomerate with a diameter of 0.2 mm or greater over a 20 cm length of film. It is considered poor if at least one agglomerate of this diameter appears before 20 cm.

The Applicant considers this dispersion text in polyethylene resins as an equivalent of the dispersion test in the previously exemplified PVC resins, the aim being to demonstrate that the agglomerated grains according to the invention are redispersible in polyolefin resins and amongst others in polyethylene resins.

The various tests and the results obtained are:

Test No. 25:

This test, illustrating the invention, uses an aqueous suspension of chalk with a BET specific surface of 3 m²/g determined according to ISO standard 9277, whose dry matter concentration is 35% with a Brookfield™ viscosity of 225 mPa.s at 100 rpm and whose granulometry is such that 50% of the particles have a diameter of less than 2 tm determined using a Sédigraph™ 5100 granulometer, and 0.5% by dry weight of a copolymer neutralised at 80% in moles by sodium carbonate and composed of:
a) 4.0% by weight of acrylic acid as a monomer with a carboxylic function
b) 96.0% by weight of methyl methacrylate as a monomer with an acrylic ester function.

The dispersion in the LLDPE polyethylene according to the criteria described above is good.

Test No. 26:

This test, illustrating the invention, uses an aqueous suspension of chalk with a BET specific surface of 3 m²/g determined according to the ISO 9277 standard, whose dry matter concentration is 30% with a Brookfield™ viscosity of 166 mPa.s at 100 rpm and whose granulometry is such that 50% of the particles have a diameter of less than 2 μm determined using a Sédigraph™ 5100 granulometer, and 0.8% by dry weight of a copolymer neutralised to 80% in moles by sodium carbonate and composed of:
a) 4.0% by weight of acrylic acid as a monomer with a carboxylic function
b) 96.0% by weight of methyl methacrylate as a monomer with an acrylic ester function.

The dispersion in the LLDPE polyethylene according to the criteria described above is good.

Scrutiny of the results of the different tests of the example shows that the agglomerated grains according to the invention are redispersible in thermoplastic resins and in particular in polyethylene resins.

### EXAMPLE 6

This example involves revealing the viscosity reducing property of the binder used for different mineral fillers and determining that the agglomerated grains according to the invention are redispersible in thermoplastic resins and especially in PVC resins.

For this purpose, for each of the following tests, carried out on an aqueous suspension of mineral filler to be tested, the Brookfield™ viscosity of the suspension is determined before and after the addition of the binding agent. The Brookfield™ viscosity is measured here with the same equipment and according to the same procedure as that in example 1.

After these Brookfield™ viscosity measurements have been made, the redispersion test is carried out by dispersion of the agglomerated grains obtained in the PVC resins, according to the same procedure and with the same equipment as those in example 3.

These various measurements were carried out for the following tests:

Test No. 27:

This test, illustrating the invention, uses an aqueous suspension of calcite with a BET specific surface of 1 m²/g determined according to ISO standard 9277, whose dry matter concentration is 64% and whose granulometry is such that 25% of the particles have a diameter of less than 2 μm determined using a Cilas™ 920 granulometer, and 10.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values obtained according to the aforementioned procedure are:
Before adding the binder:—Brookfield™ viscosity at 10 rpm=1712 mPa.s
   Brookfield™ viscosity at 100 rpm=298 mPa.s
After adding the binder:—Brookfield™ viscosity at 10 rpm=32 mPa.s
   Brookfield™ viscosity at 100 rpm=58 mPa.s

The dispersion in the PVC according to the criteria described above is good.

Test No. 28:

This test, illustrating the invention, uses an aqueous suspension of marble with a BET specific surface of 3.3 m²/g determined according to ISO standard 9277, whose dry matter concentration is 55% and whose granulometry is such that 40% of the particles have a diameter of less than 2 μm determined using a Malvern Mastersizer™ X granulometer, and 1.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values obtained according to the aforementioned procedure are:
Before adding the binder:—Brookfield™ viscosity at 10 rpm=8352 mPa.s
   Brookfield™ viscosity at 100 rpm=1350 mPa.s
After adding the binder:—Brookfield™ viscosity at 10 rpm=96 mPa.s
   Brookfield™ viscosity at 100 rpm=70 mPa.s

The dispersion in the PVC according to the criteria described above is good.

Test No. 29:

This test, illustrating the invention, uses an aqueous suspension of precipitated calcium carbonate with a BET specific surface of 10 m²/g determined according to ISO standard 9277, whose dry matter concentration is 55% and whose median diameter is 0.18 μm determined by permeability, and 1.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values obtained according to the aforementioned procedure are:
Before adding the binder:—Brookfield™ viscosity at 10 rpm=3744 mPa.s
   Brookfield™ viscosity at 100 rpm=1434 mPa.s
After adding the binder:—Brookfield™ viscosity at 10 rpm=32 mPa.s
   Brookfield™ viscosity at 100 rpm=12.8 mPa.s

The dispersion in the PVC according to the criteria described above is good.

Test No. 30:

This test, illustrating the invention, uses an aqueous suspension of talc whose dry matter concentration is equal to 43% and whose 21% of the particles have a diameter of less than 2[m determined by using a Sédigraph™ 5100 granulometer, and 1.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values obtained according to the aforementioned procedure are:
Before adding the binder:—Brookfield™ viscosity at 10 rpm=9152 mPa.s
   Brookfield™ viscosity at 100 rpm=2122 mPa.s
After adding the binder:—Brookfield™ viscosity at 10 rpm=160 mPa.s
   Brookfield™ viscosity at 100 rpm=233 mPa.s

The dispersion in the PVC according to the criteria described above is good.

Test No. 31:

This test, illustrating the invention, uses an aqueous suspension of calcite with a BET specific surface of 15 m²/g determined according to ISO standard 9277, whose dry matter concentration is 50% and whose granulometry is such that 80% of the particles have a diameter of less than 1 ttm determined using a SédigraphTM 5100 granulometer, and 1.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values obtained according to the aforementioned procedure are:
Before adding the binder:—Brookfield™ viscosity at 10 rpm=9000 mPa.s
   Brookfield™ viscosity at 100 rpm=3000 mPa.s
After adding the binder:—Brookfield™ viscosity at 10 rpm=750 mPa.s
   Brookfield™ viscosity at 100 rpm=500 mPa.s

The dispersion in the PVC according to the criteria described above is good.

Scrutiny of the results of the various tests in the example demonstrates the use of copolymer according to the invention as a viscosity reducing agent when the molecular weight corresponds to an intrinsic viscosity ranging from 5 ml/g to 20 ml/g, and preferably from 7 ml/g to 15 ml/g, measured according to method (A) described above.

### EXAMPLE 7

This example involves revealing the rheology modifying property of the binder used for a mixture of mineral fillers and determining that the agglomerated grains according to the invention are redispersible in thermoplastic resins and especially in polypropylene resins.

Accordingly, for the following test, carried out on an aqueous suspension of mineral filler to be tested, the Brookfield™ viscosity of the suspension is determined before and after adding the binding agent. The Brookfield™ viscosity is measured here with the same equipment and according to the same procedure as that in example 1.

After these Brookfield™ viscosity measurements have been made, the redispersion test is carried out by dispersion of the agglomerated grains obtained in the polypropylene resins, according to the method described below.

After drying the suspension of the next test No. 32, in the form of reconstituted grains, using a spray gun marketed by Sacmi (Italy), a mixture is made with 80 parts by weight of a polypropylene resin marketed under the name of Atofina PPH 3060 by Atofina and 20 parts by weight of the mineral filler to be tested in the form of reconstituted grains.

This mixture produced is then extruded using a Buss™ PR46-11D fitted with a 30-mm diameter twin-screw extruder with the following machine parameters:
Screw rotation speed: 80 rpm;
Temperature of extrusion zone 1: 175° C.;
Temperature of extrusion zone 2: 190° C.

The output extrudate is then converted into film by 10 tonnes of compression using a Collin apparatus.

The dispersion of the reconstituted grains is then regarded as good if there is no agglomerate with a diameter of 0.2 mm or greater over a 20 cm length of film. It is considered poor if at least one agglomerate of this diameter appears before 20 cm.

The Applicant considers this dispersion text in polypropylene resins as an equivalent of the dispersion test in the previously exemplified PVC resins, the aim being to demonstrate that the agglomerated grains according to the invention are redispersible in polyolefin resins and amongst others in polypropylene resins.

These various measurements were carried out for the following test.

Test No. 32:

This test, illustrating the invention, uses an aqueous suspension of a mixture of talc and calcium carbonate in a 50/50 weight ratio with a talc of BET specific surface of 10 m²/g determined according to ISO standard 9277, and granulometry such that 41% of the particles have a diameter of less than 2 μm determined using a Sédigraph™ 5100 granulometer, and a calcium carbonate of BET specific surface of 5 m²/g determined according to ISO standard 9277, and granulometry such that 65% of the particles have a diameter of less than 2 μm determined using a Sédigraph™ 5100 granulometer. This suspension has a dry matter concentration of 20% and a granulometry such that 60% of the particles have a diameter of less than 2 μm determined using a Sédigraph™ 5100 granulometer, and 1.0% by dry weight of a copolymer neutralised at 100% in moles by ammonia, with an intrinsic viscosity of 8.1 ml/g measured according to the aforementioned method (A) and composed of:
a) 30.0% by weight of acrylic acid as a monomer with a carboxylic function;
b) 70.0% by weight of ethyl acrylate as a monomer with an acrylic ester function.

The Brookfield™ viscosity values at 100 rpm obtained by the aforementioned procedure are, before adding the binder equal to 695 mPa.s and after adding the binder equal to 25 mPa.s.

The dispersion in the polypropylene according to the criteria described above is good.

1. Copolymer simultaneously with the function of a binding agent and the function of a rheology modifier for aqueous suspensions of pigments and/or mineral fillers, used to obtain grains of pigments and/or mineral fillers reconstituted and formed from elementary particles with a specific BET surface ranging from 0.5 m²/g to 200 m²/g as determined according to ISO standard 9277, grains that are easy to re-disperse in thermoplastic resins, characterised in that it consists of, as expressed in weight:
a) from 3% to 75%, preferably from 4% to 70% of at least one monomer with a carboxyl function,
b) from 97% to 25%, preferably from 96% to 30% of at least one monomer with an ester, or amide acrylic, or vinyl function, and
c) from 0% to 5% of at least one acid monomer containing the sulphur atom or the phosphorus atom or their mixtures,
d) from 0% to 5% in weight of at least one cross-linking monomer chosen from among the monomers with at least two ethylenic insaturations,
the sum of monomers a), b), c) and d) equals 100%.

2. Copolymer simultaneously with the function of a binding agent and the function of a viscosity reducer for aqueous suspensions of pigments and/or mineral fillers according to claim 1, characterised in that it comprises, as expressed in weight:
a) from 10% to 75% of at least one monomer with a carboxyl function,
b) from 90% to 25% of at least one monomer with an ester, or amide acrylic, or vinyl function,
c) from 0% to 5% of at least one acid monomer containing the sulphur atom or the phosphorus atom or their mixtures,
d) from 0% to 5% in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g, as measured according to method (A).

3. Copolymer simultaneously with the function of a binding agent and the function of a grinding aid agent according to claim 1, characterised in that it comprises, as expressed in weight:
a) from 30% to 75% of at least one monomer with a carboxyl function,
b) from 70% to 25% of at least one monomer with an ester, or amide acrylic, or vinyl function,
c) from 0% to 5% of at least one acid monomer containing the sulphur atom or phosphorus atom or their mixtures,
d) from 0% to 5%. in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g, measured according to method (A).

4. Copolymer according to any of claims 1 to 3 characterised in that the monomer(s) with a carboxyl function is/are chosen from among the anionic monomers with ethylenic insaturation and with monocarboxylic function such as acrylic or methacrylic acid or even the hemiesters of diacids such as the monoesters in C₁ to C₄ of maleic or itaconic acid, or their mixtures, or is/are chosen from among the anionic monomers with ethylenic insaturations and with dicarboxylic or sulphonic or phosphoric or phosphonic function or their mixture chosen from among the monomers with ethylenic insaturates and with dicarboxylic function such as itaconic, maleic acid or the anhydrides of carboxylic acids such as maleic anhydride.

5. Copolymer according to any of claims 1 to 3 characterised in that the monomer(s) with acrylic or vinyl ester or amide function is/are chosen from among acrylamide or methacrylamide whether or not substituted or their derivatives and their mixtures or even from among one or several non hydrosoluble monomers such as the branched or linear alkyl acrylates or methacrylates, or from among the vinyl esters such as vinyl acetate.

6. Copolymer according to any of claims 1 to 3 characterised in that the acid monomer(s) containing the sulphur atom or phosphorus atom or their mixtures is/are chosen from among the monomers with ethylenic insaturation and with sulphonic function such as acrylamido-methyl-propane-sulphonic acid, sodium methallylsulphonate, sulphonic vinyl acid and sulphonic styrene acid or even is/are chosen from among the monomers with ethylenic insaturation and with phosphoric function such as the phosphate of ethylene glycol methacrylate, the phosphate of propylene glycol methacrylate, the phosphate of ethylene glycol acrylate, the phosphate of propylene glycol acrylate and their ethoxylates or even is/are chosen from among the monomers with ethylenic insaturation and phosphonic function such as phosphonic vinyl acid, or their mixtures.

7. Copolymer according to any of claims 1 to 3 characterised in that the monomer(s) with at least two ethylenic insaturations is/are chosen from the group consisting of ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allylic esters obtained from polyalcohols such as pentaerythritol, sorbitol, sucrose.

8. Rheology modifier for aqueous suspensions of pigments and/or mineral fillers simultaneously with the function of a binding agent and used to obtain grains of pigments and/or mineral fillers, reconstituted and formed from elementary particles with a specific BET surface ranging from 0.5 m²/g to 200 m²/g, as determined according to ISO standard 9277, grains that can be easily re-dispersed in thermoplastic resins, characterised in that it consists of, as expressed in weight:
e) from 3% to 75%, preferably from 4% to 70% of at least one monomer with a carboxylic function,
f) from 97% to 25%, preferably from 96% to 30% of at least one monomer with an acrylic or vinyl ester or amide function,
g) from 0% to 5% of at least one acid monomer containing the sulphur atom or phosphorus atom or their mixtures, and
h) from 0% to 5% in weight of at least one cross-linking monomer chosen from among the monomers with at least two ethylenic insaturations,
the sum of monomers a), b), c) and d) equals 100%.

9. Rheology modifier according to claim 8 characterised in that the monomer(s) with a carboxyl function is/are chosen from among the anionic monomers with ethylenic insaturation and with monocarboxylic function such as acrylic or methacrylic acid or even the hemiesters of diacids such as the monoesters in C₁ to C₄ of maleic or itaconic acid, or their mixtures, or is/are chosen from among the anionic monomers with ethylenic insaturation and dicarboxylic or sulphonic or phosphoric or phosphonic function or their mixture chosen from among the monomers with ethylenic insaturation and dicarboxylic function such as itaconic, maleic acid or even the anhydrides of carboxylic acid, such as maleic anhydride.

10. Rheology modifier according to claim 8 characterised in that the monomer(s) with an acrylic or vinyl ester or amide function is/are chosen from among the acrylamide or methacrylamide whether or not substituted or their derivatives and mixtures or even from among one or several non hydrosoluble monomers such as branched or linear alkyl acrylates or methacrylates, or from among the vinyl esters such as vinyl acetate.

11. Rheology modifier according to claim 8 characterised in that the acid monomer(s) containing the sulphur atom or phosphorus atom or their mixtures is/are chosen from among the monomers with ethylenic insaturation and with sulphonic function such as acrylamido-methyl-propane-sulphonique acid, sodium methallylsulphonate, sulphonic vinyl acid and sulphonic styrene acid or even is/are chosen from among the monomers with ethylenic insaturation and with phosphoric function such as the phosphate of ethylene glycol methacrylate, the phosphate of propylene glycol methacrylate, the phosphate of ethylene glycol acrylate, the phosphate of propylene glycol acrylate and their ethoxylates or even is/are chosen from among the monomers with ethylenic insaturation and phosphonic function such as phosphonic vinyl acid, or their mixtures.

12. Rheology modifier according to claim 8 characterised in that the monomer(s) with at least two ethylenic insaturations is/are chosen from the group consisting of ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allylic ethers obtained from polyalcohols such as pentaerythritol, sorbitol, sucrose.

13. Viscosity reducer for aqueous suspensions of pigments and/or mineral fillers simultaneously with the function of binding agent, characterised in that it consists of, as expressed in weight:
a) from 10% to 75% of at least one monomer with a carboxylic function,
b) from 90% to 25% of at least one monomer with an acrylic or vinyl ester or amide function,
c) from 0% to 5% of at least one acid monomer containing the sulphur atom or phosphorus atom or their mixtures,
d) from 0% to 5% in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g, as measured according to method (A).

14. Viscosity reducer according to claim 13 characterised in that the monomer(s) with a carboxyl function is/are chosen from among the anionic monomers with ethylenic insaturation and monocarboxylic function such as acrylic or methacrylic acid or even the hemiesters of diacids such as the monoesters in C₁ to C₄ of the maleic or itaconic acids, or their mixtures, or is/are chosen from among the anionic monomers with ethylenic insaturation and dicarboxylic or sulphonic or phosphoric or phosphonic function or their mixture chosen from among the monomers with ethylenic insaturation and dicarboxylic function such as itaconic, maleic acid or even the anhydrides of carboxylic acids, such as maleic anhydride.

15. Viscosity reducer according to claim 13 characterised in that the monomer(s) with acrylic or vinyl ester or amide function is/are chosen from among the acrylamide or methacrylamide whether or not substituted or their derivatives and their mixtures or even from among one or several non hydrosoluble monomers such as the branched or linear alkyl acrylates or methacrylates, or from among the vinyl esters such as vinyl acetate.

16. Viscosity reducer according to claim 13 characterised in that the acid monomer(s) containing the sulphur atom or phosphorus atom or their mixtures are chosen from among the monomers with ethylenic insaturation and with sulphonic function such as acrylamido-methyl-propane-sulphonique acid, sodium methallylsulphonate, sulphonic vinyl acid and sulphonic styrene acid or even are chosen from among the monomers with ethylenic insaturation and phosphoric function such as the phosphate of ethylene glycol methacrylate, the phosphate of propylene glycol methacrylate, the phosphate of ethylene glycol acrylate, the phosphate of propylene glycol acrylate and their ethoxylates or even are chosen from among the monomers with ethylenic insaturation and phosphonic function such as phosphonic vinyl acid, or their mixtures.

17. Viscosity reducer according to claim 13 characterised in that the monomer(s) with at least two ethylenic insaturations is/are chosen from the group consisting of ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allylic ethers obtained from polyalcohols such as pentaerythritol, sorbitol, sucrose.

18. Grinding aid agent simultaneously with the function of a binding agent, characterised in that it comprises, as expressed in weight:
a) from 30% to 75% of at least one monomer with a carboxyl function,
b) from 70% to 25% of at least one monomer with an acrylic or vinyl ester or amide function,
c) from 0% to 5% of at least one acid monomer containing the sulphur atom or phosphorus atom or their mixtures,
d) from 0% to 5% in weight of at least one cross-linking monomer chosen from among the monomers with at least two ethylenic insaturations,
the sum of monomers a), b), c) and d) equals 100%,
and in that it has a molecular weight corresponding to an intrinsic viscosity ranging from 5 ml/g to 20 ml/g, and preferably from 7 ml/g to 15 ml/g, as measured according to method (A).

19. Grinding aid agent according to claim 18 characterised in that the monomer(s) with carboxyl function is/are chosen from among the anionic monomers with ethylenic insaturation and monocarboxylic function such as acrylic or methacrylic acid or even the hemiesters of diacids such as the monoesters in C₁ to C₄ of maleic or itaconic acids, or their mixtures, or is/are chosen from among the anionic monomers with ethylenic insaturation and dicarboxylic or sulphonic or phosphoric or phosphonic function of their mixture chosen from among the monomers with ethylenic insaturation and dicarboxylic function such as itaconic, maleic acid, or even the anhydrides of carboxylic acids, such as maleic anhydride.

20. Grinding aid agent according to claim 18 characterised in that the monomer(s) with an acrylic or vinyl ester or amide function is/are chosen from among the acrylamides or methacrylamides whether nor not substituted or their derivatives and their mixtures or from among one or several non hydrosoluble monomers such as the branched or linear alkyl acrylates or methacrylates, or from among the vinyl esters such as vinyl acetate.

21. Grinding aid agent according to claim 18 characterised in that the acid monomer(s) containing the sulphur atom or the phosphorus atom or their mixtures is/are chosen from among the monomers with ethylenic insaturation and sulphonic function such as acrylamido-methyl-propane-sulphonic acid, sodium methallylsulphonate, sulphonic vinyl acid and sulphonic styrene acid or are chosen from among the monomers with ethylenic insaturation and phosphoric function such as the phosphate of ethylene glycol methacrylate, the phosphate of propylene glycol methacrylate, the phosphate of ethylene glycol acrylate, the phosphate of propylene glycol acrylate and their ethoxylates or even is/are chosen from among the monomers with ethylenic insaturation and phosphonic function such as phosphonic vinyl acid, or their mixtures.

22. Grinding aid agent according to claim 18 characterised in that the monomer(s) with at least two ethylenic insaturations is/are chosen from the group consisting of ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allylic ethers obtained from polyalcohols such as pentaerythritol, sorbitol, sucrose.

23. Use of a copolymer, as a binding agent and as a rheology modifier for aqueous suspensions of pigments and/or mineral fillers, used to obtain the grains of pigments and/or mineral fillers that are reconstituted and formed from elementary particles with a specific BET surface ranging from 0.5 m²/g to 200 m²/g, as determined according to ISO standard 9277, grains that can easily be re-dispersed in thermoplastic resins, characterised in that the aforementioned copolymer comprises, as expressed in weight:
a) from 3% to 75%, preferably from 4% to 70% of at least one monomer with a carboxyl function,
b) from 97% to 25%, preferably from 96% to 30% of at least one monomer with an acrylic or vinyl ester or amide function,
c) from 0% to 5% of at least one acid monomer containing the sulphur atom or phosphorus atom or their mixtures, and
d) from 0% to 5% in weight of at least one cross-linking monomer chosen from among the monomers with at least two ethylenic insaturations,
the sum of monomers a), b), c) and d) equals 100%,
characterised in that the aforementioned copolymer is used at the rate of 0.1% to 10% in dry weight compared with the dry weight of the pigments and/or mineral fillers,
and in that the agglomerated grains of pigments and/or mineral fillers can be re-dispersed in PVC resins, that is, that there are less than 3 grains with a diameter equal to or greater than 0.2 mm in the re-dispersion test based on the protocol to measure the dispersal power of microgranulates in PVC resins.

24. Use of a copolymer, as a binding agent or viscosity reducer for aqueous suspensions of pigments and/or mineral fillers according to claim 23, characterised in that the aforementioned copolymer comprises, as expressed in weight:
a) from 10% to 75% of at least one monomer with a carboxyl function,
b) from 90% to 25% of at least one monomer with an acrylic or vinyl ester or amide function,
c) from 0% to 5% of at least one acid monomer containing the sulphur atom or phosphorus atom or their mixtures,
d) from 0% to 5% in weight of at least one cross-linking monomer chosen from among the monomers with at least two ethylenic insaturations,
the sum of monomers a), b), c) and d) equals 100%,
characterised in that the aforementioned copolymer is used at the rate of 0.1% to 10% in dry weight compared with the dry weight of pigments and/or mineral fillers,
and in that it has a molecular weight corresponding to an intrinsic viscosity ranging from 5 ml/g to 20 ml/g, and preferably from 7 ml/g to 15 ml/g, as measured according to method (A).
and in that the agglomerated grains of pigments and/or mineral fillers can be re-dispersed in PVC resins, that is, that there are less than 3 grains with a diameter equal to or greater than 0.2 mm in the re-dispersion test based on the protocol to measure the dispersal power of microgranulates in PVC resins.

25. Use of a copolymer, as a binding agent and as a grinding aid agent for aqueous suspensions of pigments and/or mineral fillers according to claim 23, characterised in that the aforementioned copolymer consists of, as expressed in weight:
a) from 30% to 75% of at least one monomer with a carboxyl function,
b) from 70% to 25% of at least one monomer with an acrylic or vinyl ester or amide function,
c) from 0% to 5% of at least one acid monomer containing the sulphur atom or phosphorus atom or their mixtures,
d) from 0% to 5% in weight of at least one cross-linking monomer chosen from among the monomers with at least two ethylenic insaturations,
the sum of monomers a), b), c) and d) equals 100%,
characterised in that the aforementioned copolymer is used at the rate of 0.1% to 10% in dry weight compared with the dry weight of pigments and/or mineral fillers,
and in that it has a molecular weight corresponding to an intrinsic viscosity ranging from 5 ml/g to 20 ml/g, and preferably from 7 ml/g to 15 ml/g, as measured according to method (A),
and in that the agglomerated grains of pigments and/or mineral fillers can be re-dispersed in PVC resins, that is, that there are less than 3 grains with a diameter equal to or greater than 0.2 mm in the re-dispersion test based on the protocol to measure the dispersal power of microgranulates in PVC resins.

26. Use of a copolymer according to any of claims 23 to 25, characterised in that the monomer(s) with a carboxyl function is/are chosen from among the anionic monomers with ethylenic insaturation and with a monocarboxylic function such as acrylic or methacrylic acid or even the hemiesters of diacids such as the monoesters in C₁ to C₄ of maleic or itaconic acid or their mixtures, or is/are chosen from among the anionic monomers with ethylenic insaturation and with dicarboxylic or sulphonic or phosphoric or phosphonic function or their mixture chosen from among the monomers with ethylenic insaturation and with dicarboxylic function such as itaconic or maleic acid, or even the anhydrides of carboxylic acids, such as maleic anhydride.

27. Use of a copolymer according to any of claims 23 to 25 characterised in that the monomer(s) with an acrylic or vinyl ester or amide function is/are chosen from among the acrylamide or methacrylamide whether or not substituted or their derivatives and their mixtures or even from among one or several non hydrosoluble monomers such as the branched or linear alkyl acrylates or methacrylates, or from among the vinyl esters such as vinyl acetate.

28. Use of a copolymer according to any of claims 23 to 25 characterised in that the acid monomer(s) containing the sulphur atom or phosphorus atom or their mixtures is/are chosen from among the monomers with ethylenic insaturation and with sulphonic function such as acrylamido-methyl-propane-sulphonic acid, sodium methallylsulphonate, sulphonic vinyl acid and sulphonic styrene acid or even is/are chosen from among the monomers with ethylenic insaturation and with phosphoric function such as the phosphate of ethylene glycol methacrylate, the phosphate of propylene glycol methacrylate, the phosphate of ethylene glycol acrylate, the phosphate of propylene glycol acrylate and their ethoxylates or even is/are chosen from among the monomers with ethylenic inisaturation and phosphonic function such as phosphonic vinyl acid, or their mixtures.

29. Use of a copolymer according to any of claims 23 to 25 characterised in that the monomer(s) with at least two ethylenic insaturations is/are chosen from the group consisting of ethylene glycol dimethacrylate, trimethylolpropanetriacrylate, allyl acrylate, the allyl maleates, methylene-bis-acrylamide, methylene-bis-methacrylamide, tetrallyloxyethane, the triallylcyanurates, the allylic ethers obtained from polyalcohols such as pentaerythritol, sorbitol, sucrose.

30. Grains of pigments and/or mineral fillers, reconstituted and formed from elementary particles with a specific BET surface ranging from 0.5 m²/g to 200 m²/g, as determined according to ISO standard 9277, that can easily be re-dispersed in thermoplastic resins, characterised in that they contain from 0.1% to 10% in weight, with respect to the dry weight of pigments and/or mineral fillers, of the copolymer according to any of claims 1 to 7.

31. Reconstituted grains of pigments and/or mineral fillers according to claim 30, characterised in that the filler and/or pigment is chosen from among natural calcium carbonate such as calcite, chalk or even marble, synthetic calcium carbonate still called precipitated calcium carbonate, the dolomites, magnesium hydroxide, kaolin, talc, gypsum, titanium oxide, hydrotalcite, or their mixtures.

32. Use of grains of pigments and/or mineral fillers according to claim 31 in the domains using fine powders, in particular in the domain of paints and in the domain of thermoplastic resins and, even more particularly in the domain of PVC resins and polyolefin resins.

33. Thermoplastic resin manufactured by the use of grains of pigments and/or mineral fillers according to claim 32.

34. Thermoplastic resin according to claim 33 characterised in that it contains, with respect to the total weight of the resin, from 1% to 85% in dry weight, preferably from 2% to 40% in dry weight, of grains of pigments and/or mineral fillers according to any of claims 30 or 31.

35. PVC resin and polyolefin resin manufactured by the use of grains of pigments and/or mineral fillers according to any of claims 33 or 34.

36. Objects injected, moulded or extruded from thermoplastic resins and in particular PVC resins according to claim 35.
